(19) United States
(12) Patent Application Publication
(10) Pub. No.: US 2008/0095086 A1
(43) Pub. Date: Apr. 24, 2008

(54) METHOD OF DEPLOYING AN ACCESS POINT FOR AN IP-BASED WIRELESS NETWORK

(76) Inventors: Janne Linkola, Espoo (FI); Jelena Senour, Issaquah, WA (US); Amy Grimes, Bellevue, WA (US)

Correspondence Address: PERKINS COIE LLP;PATENT-SEA, P.O. BOX 1247, SEATTLE, WA, 98111-1247, US

(21) Appl. No.: 11/552,089

(22) Filed: Oct. 23, 2006

(51) Int. Cl. H04B 7/00

(52) U.S. Cl. 370/310

(57) ABSTRACT

A method of deploying a wireless router as an access point for an IP-based wireless telecommunications network. The wireless router is packaged with a tutorial on a compact disc in such a way that a user unpacking the wireless router is clearly instructed to insert the compact disc into a computer prior to continuing with any set-up. Once the compact disc is inserted into a computer, a set-up facility guides the user in a step-by-step fashion on how to install and appropriately configure the wireless router for use with a mobile communication device. Security between the wireless router and the communication device may be automatically enabled by depressing a button on the wireless router.

### BACKGROUND

A variety of technologies enable telecommunication services to be offered using Internet Protocol (IP). Commonly referred to as Voice over IP, or VoIP, such technologies enable telecommunications on any public or private IP network, including the Internet. VoIP technology permits a user to receive IP-based telecommunications services through a variety of devices, including a desktop computer, a notebook computer, an analog handset used in conjunction with a VoIP telephone adapter, a VoIP-enabled handset, or other like device.

Increasingly, mobile devices, such as notebook computers, personal digital assistants (PDAs), wireless handhelds, wireless handsets, or other similar devices, are also being enabled to receive IP-based telecommunications services. Such services are provided by enabling the mobile device to communicate with a wireless router and access any IP-based wireless access network, such as a network based on the IEEE 802.16 (WiMAX), IEEE 802.20 Mobile Broadband Wireless Access (MBWA), Ultra Wideband (UWB), 802.11 wireless fidelity (Wi-Fi), and Bluetooth standards.

Moreover, dual-mode mobile telecommunications devices may be enabled to communicate with any IP-based wireless access network. For instance, Unlicensed Mobile Access (UMA) technology allows wireless service providers to merge cellular networks, such as Global System for Mobile Communications (GSM) networks, and IP-based wireless networks into one seamless service with one mobile device, one user interface, and a common set of network services for both voice and data. UMA technology has recently been accepted into release 6 of the 3rd Generation Partnership Project (3GPP) standard as a General Access Network (GAN). With UMA or GAN solutions, subscribers may move between cellular networks and IP-based wireless networks with seamless voice and data session continuity as transparently as they move between cells within the cellular network. Seamless in-call handover between the IP-based wireless network and cellular network ensures that the user's location and mobility do not affect the services delivered to the user. Services may be identical whether connected over the IP-based wireless network or the cellular network. UMA technology effectively creates a parallel radio access network, the UMA network, which interfaces to the mobile core network using standard mobility-enabled interfaces. The mobile core network remains unchanged. The common mobile core network makes it possible for the service provider to have full service and operational transparency. The existing service provider Business Support Systems (BSS), service delivery systems, content services, regulatory compliance systems, and Operation Support Systems (OSS) can support the UMA network without change. Service enhancements and technology evolution of the mobile core network apply transparently to both cellular access and UMA.

Although IP-based wireless telecommunications technologies offer substantial benefits to users, service providers may face many obstacles to the widespread adoption and use of these technologies. Often, users are very hesitant to embrace new technologies with which they are not familiar. The service providers must therefore convince users of the benefits of using an IP-based mobile device and related services, including by making the solution easy for a user to deploy. Offering a user an IP-based wireless telecommunications service is different than offering standard telecommunications service, or standard wireless telecommunications service, in that a portion of the IP-based wireless telecommunications technology may need to be deployed by the user if the user is to take full advantage of the technology. Specifically, the user may desire to deploy an access point in his or her home, office, or other frequented location. Such a deployment may not only lead to user frustration and an increase in customer service calls to the service provider if deployment proves difficult, but also to a potential loss of a customer. As a result, it would be beneficial for the service provider to simplify the deployment process so that a user can quickly and easily begin to use the IP-based wireless telecommunications service with a minimum amount of assistance from the service provider.

### BRIEF DESCRIPTION OF THE DRAWINGS

FIG. 1 illustrates an example Voice over IP system.

FIGS. 2A and 2B illustrate example converged wireless network systems that combine cellular networks with IP-based wireless telecommunications networks.

FIG. 3 illustrates a network controller configured in an IP-based wireless telecommunication network to authorize or reject access based on various identifiers.

FIG. 4 is a perspective view of product packaging that includes components for implementing an access point for an IP-based wireless telecommunications network.

FIGS. 5A and 5B are flow charts of a process for instructing a user on how to deploy the access point for an IP-based wireless telecommunications network.

FIG. 6 is a communication diagram of messaging for securely pairing a mobile device and an access point.

FIG. 7 are screenshots of a mobile device interface when securely pairing a mobile device and an access point.

### DETAILED DESCRIPTION

The following description provides specific details for a thorough understanding of, and enabling description for, various embodiments of the technology. One skilled in the art will understand that the technology may be practiced without these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

### I. EXAMPLE VoIP AND UMA NETWORKS

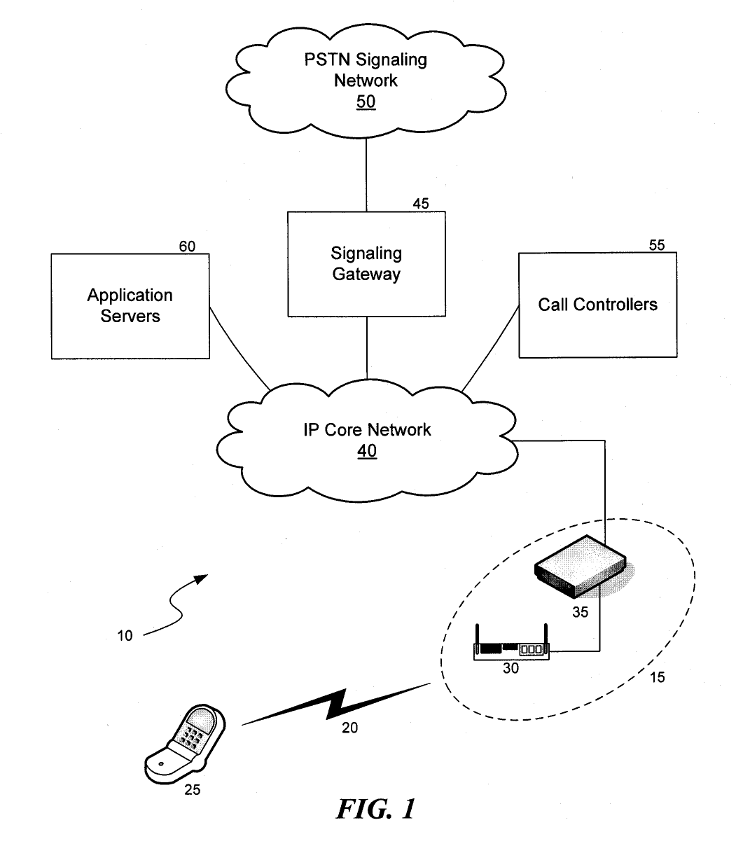

FIG. 1 illustrates the components of a generalized Voice over Internet Protocol (VoIP) system 10 for mobile communication devices. The system comprises one or more access points (APs) 15 that can accept communications 20 from mobile devices 25. The access point includes a wireless router 30 and a broadband modem 35 that enable connection to an Internet Protocol (IP) network 40. IP network 40 may be one or more public networks, private networks, or combination of public and private networks. IP packets that carry communications from the mobile device 25 are received at the access point 15 and transported through the IP network 40 to a signaling gateway 45. Signaling gateway 45 is typically operated by a service provider and converts the VoIP signal to a traditional phone service signal. The phone signal is then conveyed to the intended recipient via a public switched telephone network (PSTN) 50. A call controller 55 that is located in the service provider's network provides call logic and call control functions. An application server 60 that is located in the service provider's network provides logic and execution of one or more applications or services that are offered by the server provider, such as implementing various access and security rules.

The VoIP system depicted in FIG. 1 is an architecture that broadly enables any mobile device to receive IP-formatted telecommunication services. One application of this technology is Unlicensed Mobile Access (UMA) technology, which allows cellular service providers to offer their products and services seamlessly over Internet-connected broadband networks. Mobile devices may utilize licensed, semilicensed and unlicensed spectrums (such as spectrums for cellular communications) and alternate licensed and unlicensed spectrums (such as spectrums for IP-based wireless communication). For example, dual-mode cellular phones may access a cellular network, such as a GSM, CDMA, or other network, or an IP-based wireless network, such as a network based on the IEEE 802.16 (WiMAX), IEEE 802.20 Mobile Broadband Wireless Access (MBWA), Ultra Wideband (UWB), 802.11 wireless fidelity (Wi-Fi), or Bluetooth standards. The IP-based networks are accessed via wireless access points that are typically connected to a DSL (Digital Subscriber Line) modem, a cable modem, a satellite modem, or any other broadband Internet connection. The access points may be open or closed, and may be located in a subscriber's home, in other apartments or residences, in public locations such as coffee shops, libraries, or schools, or in corporate locations.

When a mobile device accesses an IP-based wireless network, information is initially formatted in the cellular system's native protocol (e.g., GSM, CDMA) and then encapsulated into Internet Protocol (IP) packets, transmitted to the access point, and communicated over the Internet to the cellular service provider's mobile core network. Such transmission bypasses the service provider's existing network of radio towers. Because the same cellular protocols are used in communications involving IP access points as with traditional radio towers, the cellular service provider maintains a large degree of system compatibility even though using an IP-based network. The systems of the cellular service provider that deliver content and handle mobility may not even need to be aware that a subscriber's mobile device is on an IP-based wireless telecommunications network. The system may instead assume the mobile device is on its native cellular network. The IP network is therefore abstracted with respect to the cellular network, regardless of whether the mobile device connects to the cellular network via a cell tower (for licensed spectrum access) or a wireless access point (for licensed, semilicensed or unlicensed spectrum access).

A non-exhaustive list of products and services available on IP-based wireless telecommunications networks includes not only voice services, but also supplementary services like call forwarding and call waiting, text messaging services like SMS, and data-based services like ringtone downloads, game downloads, picture messaging, email and web browsing. Further, since a mobile device is connected to an IP network, all manner of data services available over such networks may be provided to the mobile device.

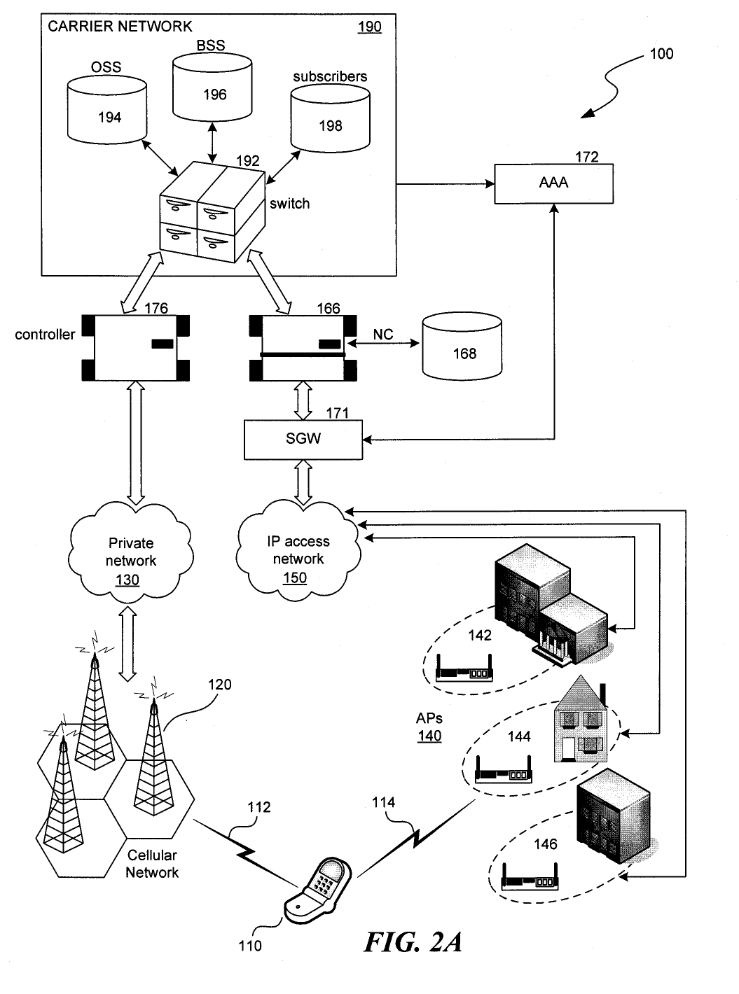

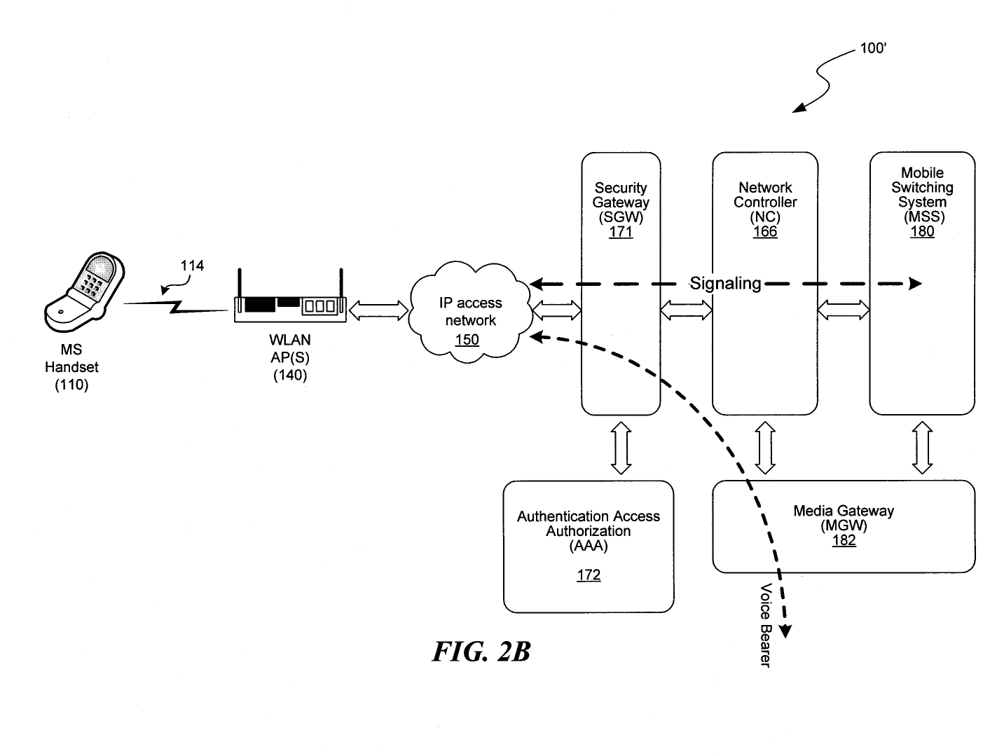

FIG. 2A is an illustration of a system 100 that combines a cellular telephone network with an IP-based wireless telecommunications network (e.g. a UMA network). The described system 100 accepts registration requests and communication connections from a mobile device 110 to either a cellular telephone network or to an IP-based wireless telecommunications network.

The example cellular telephone network includes one or more cell towers 120 that are configured to accept cellular communications 112 from mobile device 110. The cell towers 120 are connected to a controller (such as a base station controller/radio network controller (BSC/RNC)) 176 via a private network 130. The private network 130 can include a variety of connections such as T1 lines, a wide area network (WAN), a local area network (LAN), various network switches, and other similar components. Controller 176 controls network communication traffic to the carrier network 190, where all communications are managed. An example carrier network 190 includes a switch (such as a mobile switching center (MSC)) 192, which is configured to control data/call flows, perform load balancing, as well as other functions. A variety of system databases may also be accessed in the carrier network such as, e.g., an operation support subsystem (OSS) database 194, a business support system (BSS) database 196, and a central subscriber database that contains details of a carrier's subscribers (such as a home location register (HLR)) 198, for billing, call logging, etc.

The example network includes one or more access points (APs) 140 that can accept IP communications 114 from mobile device 110. An access point can be configured as part of a wireless network in one or more locations such as a public network 142, a home network 144, or a private business network 146. Each access point is coupled to an Internet Protocol (IP) network 150 through a broadband connection. IP packets that carry communications (data, voice, SMS, etc.) are routed from the access points to a security gateway (SGW) 171 through the IP network 150. The security gateway controls access to the network controller (NC) 166, which communicates with a database 168 for logging and accessing various data associated with communications. The network controller 166 is also configured to manage access with the carrier network 190 in a similar manner to that performed by the cellular network's cell tower controller 176.

Authentication of a request for access by a mobile device over the IP-based wireless telecommunications network is handled by the security gateway 171, which communicates with an authentication, access and authorization (AAA) module 172 as shown in FIG. 2A. Challenges and responses to requests for access by the mobile device are communicated between central subscriber database 198 and the AAA module 172. When authorization is granted, the security gateway 171 communicates the assignment of an IP address to the mobile device 110 that requested access. Once the IP address is passed to the mobile device 110 by the security gateway 171, the public IP address assigned to the device is passed to the NC.

FIG. 2B illustrates another example system that combines a cellular telephone network with an IP-based wireless telecommunications network. The described system 100′ accepts registration requests and communication connections from a mobile device 110 to either a cellular telephone network (not shown) or to an IP-based wireless telecommunications network. The system 100′ includes one or more access points (AP) 140 that accept communications 114 from mobile device 110. Each access point is coupled to an IP-based wireless telecommunications network 150 through a broadband connection. IP network 150 routes communications (data, voice, SMS, etc.) between the access points and a security gateway (SGW) 171. The security gateway 171 controls access to the network controller (NC) 166, which communicates with a database (not shown) for logging and accessing various data associated with communications. Authentication, access, and authorization are handled by SGW 171 via AAA module 172, as previously described.

For the example system 100′, the signaling path of a communication is routed through the NC 166 to a mobile switching system (MSS) 180, while the voice bearer path is routed through the NC 166 to a media gateway (MGW) 182. The signaling portion of a communication governs various overhead aspects of the communication such as, for example, when the communication starts, when the communication stops, initiating a telephone ring, characteristics of the transmitted data, etc. The voice bearer portion of the communication contains the actual content (either data or voice information) of the communication. The MGW 182 controls the content flow between the service provider and the mobile device 110, while the MSS 180 controls the signaling flow (or controls overhead-related flow) between the service provider and the mobile device 110.

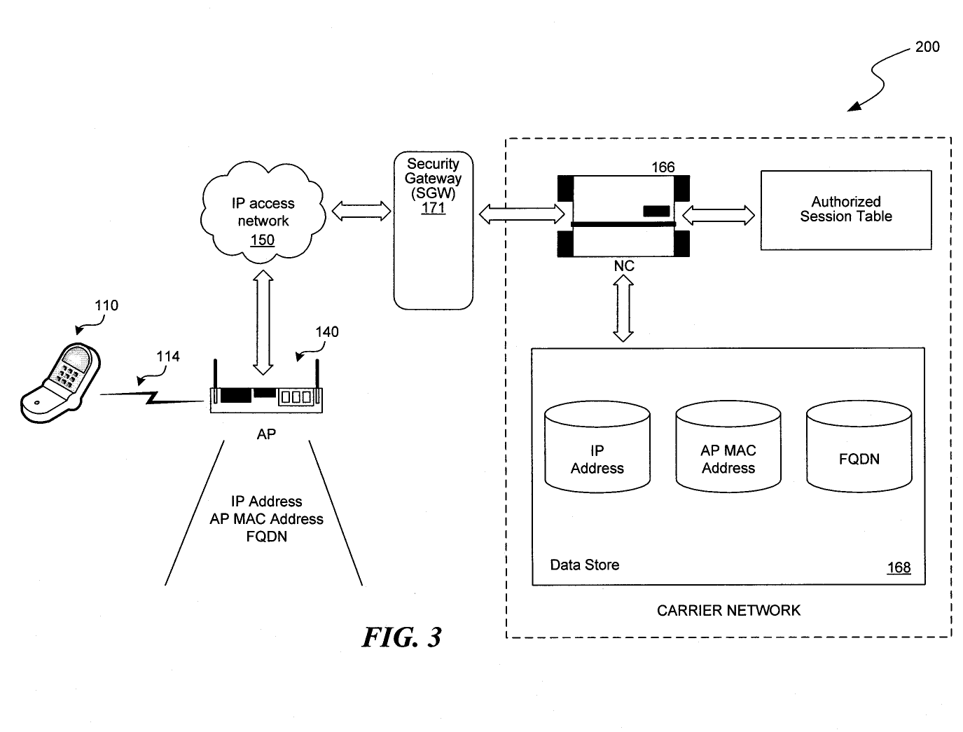

FIG. 3 illustrates a configuration that utilizes a network controller for managing IP-based network authorization. A mobile device 110 initiates a connection request with an IP-based wireless telecommunications network via a wireless communication 114 to an access point (AP) 140. The access point 140 communicates with a network controller 166 via an IP access network 150 and a security gateway (SGW) 171. The network controller 166 monitors connection requests associated with each mobile device, processes each connection request, and either permits or rejects access to the IP-based wireless telecommunications network. Access to the IP-based wireless telecommunications network may be controlled based on at least one identifier that is associated with the mobile device. The IP-based wireless telecommunications network controller 166 queries a data store 168 to determine if the mobile device 110 is authorized for access to the IP-based wireless telecommunications network. Example identifiers that may be utilized to determine access includes a media access control (MAC) address associated with an access point, a mobile device or subscriber identifier (such as an International Mobile Subscriber Identifier (IMSI)), an Internet Protocol (IP) address (or “Public IP address”) associated with the access point, a fully qualified domain name (FQDN), or other similar types of information. The data store 168 may be a single database, table, or list, or a combination of databases, tables, or lists, such as one for IP addresses, one of MAC addresses, and one for FQDNs. The data store may include “blocked” identifiers as well as “authorized” identifiers. Authorized accesses to the IP-based wireless telecommunications network may be maintained by the network controller 166 in an authorized session table or similar data construct.

### II. ACCESS NODE DEPLOYMENT

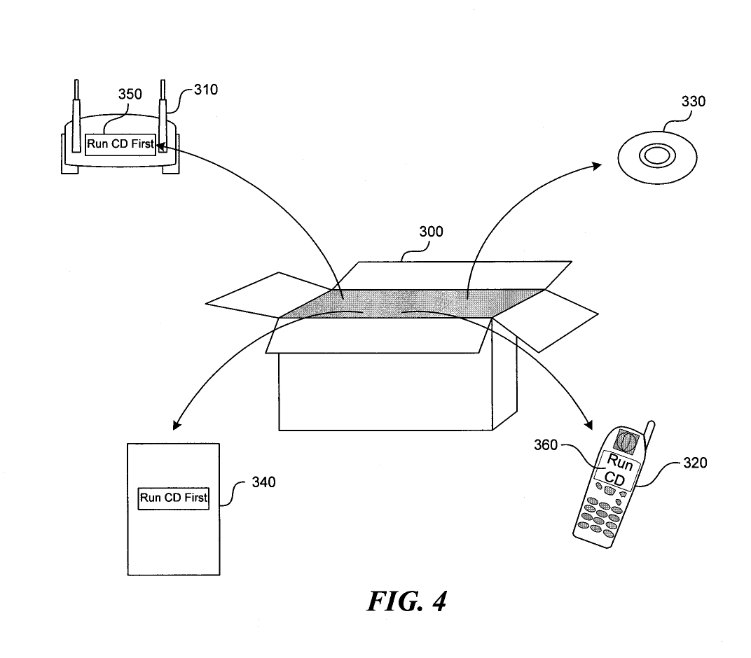

One of the factors that may influence the adoption and use of IP-based wireless telecommunications technology is the ease with which a user may purchase a IP-based wireless telecommunications device and begin using the service offered by a service provider. The simpler the deployment process is made, the more likely that users will be willing to adopt and use the technology. FIG. 4 is a perspective view of representative product packaging 400 that contains various components of an IP-based wireless telecommunications service offering by a service provider. Product packaging 400 is depicted as a single box, but may be one or more boxes, blister packs, or other packaging that allows for the safe and efficient delivery of the various components. Within the packaging are a number of components that are to be utilized by the user to deploy an access point for IP-based wireless telecommunications service. Also contained in the packaging are instructional materials that are designed to walk the user through the deployment and use of the provided components in a step-by-step fashion. Specifically, the product packaging contains some or all of the following components:
A wireless router 310 and associated cabling and power cords (not shown). The router is intended to be utilized as a wireless access point to an IP network, and may be installed by the user in his or her home, office, or other location that he or she frequents and where he or she desires to use the IP-based wireless telecommunications service. The wireless router may be any of a variety of routers, including routers made by Linksys such as model number WRT54G™. The router must have sufficient communication and processing capability to handle wireless calls made by one or more users from a mobile device, as well to implement the other functionality described herein.
A mobile device 320 that is enabled to access an IP-based telecommunications network. Such a mobile device may be manufactured by a variety of manufacturers, including Motorola, Samsung, Nokia, and others. In certain dual-mode devices, the mobile device may further be configured to operate in a first mode wherein communication is made via traditional cellular networks and in a second mode wherein communication is made via an IP-based network. Further details about switching between the various modes of operation on a dual-mode mobile device is discussed in commonly assigned U.S. patent application Ser. No. 11/480,775, entitled “SYSTEM AND METHOD FOR OPERATING A MOBILE DEVICE, SUCH AS PROVIDING AN OUT OF BOX CONNECTION SYSTEM FOR UMA TYPE MOBILE DEVICES,” which is herein incorporated in its entirety by reference.
An installation and use compact disc (CD) 330, which is to be inserted into a computer (not shown) that will be coupled to the wireless router 310. The CD includes appropriate programs and help files that, when run, provide step-by-step instructions to a user about the deployment and use of the various IP-based telecommunications components.
An installation and use guide 340, which is a paper copy of some or all of the materials that are included in the CD 330. The installation and use guide is typically redundant to the CD and any online guides provided by the service provider, so may be omitted if users no longer desire to receive a hard copy.
   While the product packaging 300 is depicted as containing four system components, it will be appreciated that a greater or lesser number of components may be included in the packaging depending on the intended service offering by the service provider. For example, certain users may not require a mobile device 320 if they already are in possession of such a device. Moreover, some manufacturers may ship or deliver some of the components directly to consumers, without providing the components to the service providers.

The intent of the product packaging 300 and the labeling of the components in the packaging is to make it very clear to the user how to proceed with deployment of the components. To that end, each component in the packaging and the packaging itself may contain messaging that indicates that the CD 330 should be inserted into a computer and a program on the CD run before any further steps are taken to connect or power on any of the components. For example, the flaps on the product packaging 300 may be clearly labeled “Run CD First” in various locations so that the very first message that a user receives as he or she opens the product packaging is to run the CD. Similarly, the various components may also have permanent or temporary stickers that contain a message to insert the CD into a computer before unpacking or using any of the other components. For example, a sticker 350 may be located on the router 310 and a sticker 360 may be located on the mobile device 320, each sticker repeating the message to insert the CD into the computer before powering-up or using the associated component. The sticker may be located in a fashion on each component that a user would be forced to remove the sticker prior to connecting or powering on the associated component. For example, the sticker 350 may extend across the power button on the router 310. Other components within the product packaging, such as the CD 330 and the installation guide 340 may have similar and prominent messaging on the face of each of these components. In addition to appropriate labeling, the components in the product packaging may also be packed in a manner that the first component that the user views upon opening the packaging is the CD. The user must physically move the CD (with the messaging on the CD) in order to access the other components in the packaging. The prominent placement and frequent repetition of the message to execute programs on the CD first significantly increases the likelihood that a user will follow the instructions and utilize the CD before performing any other actions.

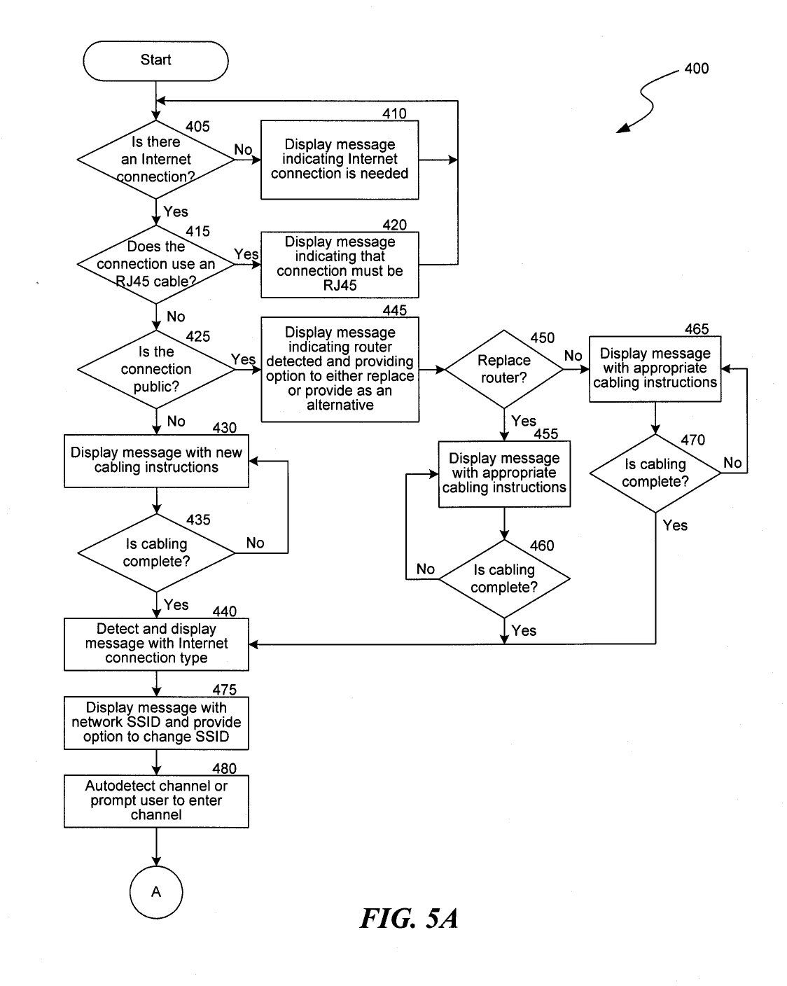

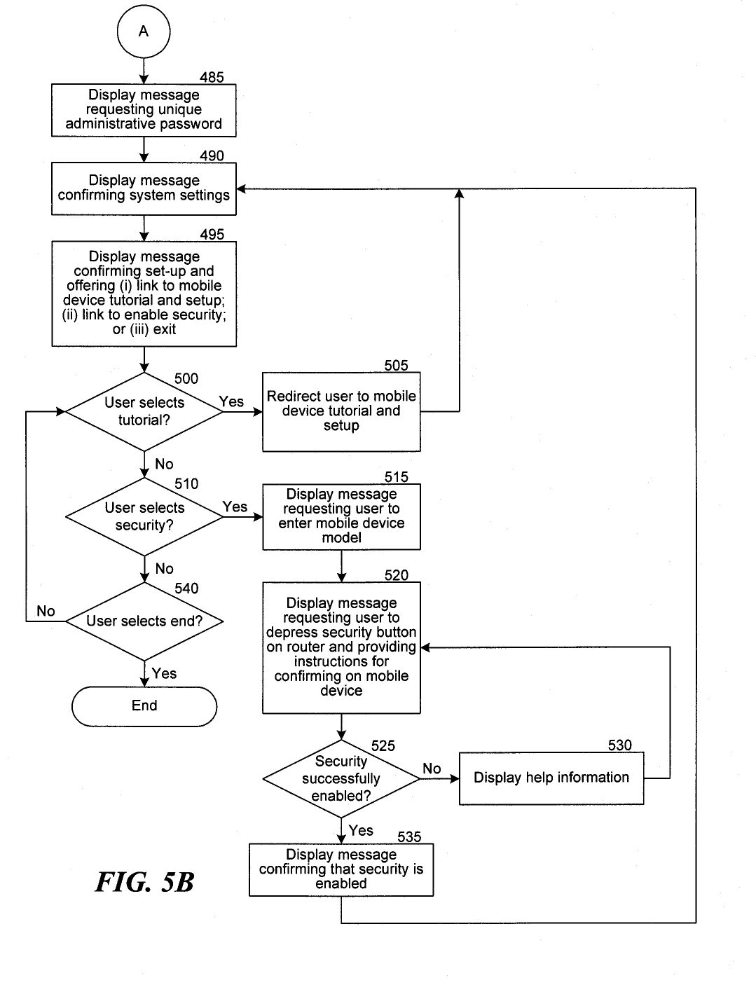

If the user inserts the CD into a computer, the CD automatically loads a set-up software facility (often referred to as a “set-up wizard”) that guides the user through the deployment process. FIGS. 5A and 5B are flow charts of the set-up process 400 that is implemented by the facility. At a decision block 405, the facility determines whether the computer is connected to the Internet by attempting to access or otherwise ping a remote network address. If the computer is not connected to the Internet, at a block 410 a message is displayed to a user indicating that a broadband Internet connection is required for the access point to be installed. Set-up is thereafter halted until the user is able to provide a broadband connection for the computer. If the facility determines that the computer is connected to the Internet, setup continues to a decision block 415. At decision block 415, the facility determines whether the computer is connected to a broadband modem with an RJ45 cable, or whether the Internet connection is implemented using another type of connection (e.g., a wireless connection or USB cable). In some embodiments, installation of the access point router depends on the computer being connected with an RJ45 cable. As a result, if the connection between the computer and the broadband modem is anything other than an RJ45 cable, at a block 420 the user is notified that the modem must be connected to the computer with an RJ45 cable. Further set-up is thereafter halted until the user is able to connect the modem using an RJ45 cable.

Once it is determined that the computer is connected to the Internet using an appropriate cable to the broadband modem, at a decision block 425 the facility determines if the connection is a public connection or a private connection. If the connection is a private connection (i.e., the connection is not shared with other parties using a router) at a block 430 the facility displays a message that provides cabling instructions to connect the router 310 between the modem and the computer. At a decision block 435 the facility tests to see if the cabling has been correctly installed. If it has, the setup process proceeds to a block 440, otherwise the facility loops back to block 430 to again provide cabling instructions to the user and information about common set-up problems. The setup process does not proceed past block 435 until the router is correctly connected between the computer and the modem.

If the connection is determined to be a public connection at decision block 425 (i.e., the connection is shared with other computers using a router), the facility proceeds to block 445. At block 445, the facility displays a message to the user indicating that a router has been detected in the system and offering the user the option of either replacing the router or supplementing the existing router with the new router 310 offered by the service provider. For many users, it may be advantageous to replace the existing router with a new router from the service provider because the new router may be configured to provide superior IP-based telecommunications service when communicating with a mobile handset. Such improved service may include, but not be limited to: (i) extended wireless coverage; (ii) increased customer care support; (iii) easy secure set-up (as described in additional detail below); (iv) improved voice quality and battery life for the corresponding handset as a result of certain signaling conventions, and (v) prioritization of telecommunication traffic (e.g., voice packets) through the router as compared with other non-telecommunication traffic. At a decision block 450, the facility receives a response from the user as to whether they desire to replace their existing router. If the user elects to replace their existing router, at a block 455 the facility displays a message with appropriate cabling instructions to connect the router 310 between the modem and the computer. At a decision block 460, the facility determines whether the cabling has been completed correctly, and if so, continues to block 440. Returning to decision block 450, if the user elects not to replace their existing router, at a block 465 the facility displays a message with appropriate cabling instructions to connect the router 310 to the existing modem, router, and computer. At a decision block 470, the facility determines whether the cabling has been completed correctly, and if so, continues to block 440.

Once the cabling has been accurately completed, the facility may configure the router for the user. At a block 440, the facility detects the Internet connection type (e.g., DHCP, PPPOE) and displays the Internet connection type to the user. In some embodiments, the user is allowed to change the Internet connection type if they so desire. At a block 475, the facility displays a message with the current (default) wireless network name (SSID) and provides an option for a user to select a different SSID name, if they so choose. Selecting a different name allows the user to easily distinguish their own access point from other nearby wireless networks. At a block 480, the facility detects which channel is being used by the user's router. The channel is shared by all computers within the user's wireless network, and may be selectively changed by the user if the user experiences poor performance on a certain channel.

At a block 485, the facility displays a message asking the user to enter an administrative password for the router. The administrative password protects the routers from undesired access and modifications to the router settings. At a block 490, the facility displays a message that confirms all of the current system settings. These settings may include, but not be limited to, one or more of the following elements: the router's address, password, wireless network name (SSID), channel, encryption (enabled or disabled), passphrase and key. The user is encouraged to print the system settings for future reference should problems arise in the future.

At a block 495, the facility displays a message confirming set-up of the access point. The facility also provides a number of additional configuration options that a user may select, including, but not limited to, an option to view a tutorial or other instructional materials about the mobile device, an option to enable security on the access point, or an option to exit the facility. At a decision block 500, the facility determines whether a user has selected the option of viewing a tutorial. If the user has selected the tutorial, at a block 505, the user is redirected to further instructional materials on the mobile device. The instructional materials may include general information about the use of a Wi-Fi network to make calls, as well as specific materials about features of the mobile device. The tutorial may be stored on the CD and viewed when selected by the user, or the user may be redirected to a web page or other online resource to view the tutorial. When the user stops viewing the tutorial, or when the tutorial is complete, the set-up process returns to block 490.

At a decision block 510, the facility determines whether a user has selected the option of enabling security on the access point. If the user has selected the option of enabling security, at a block 515 the facility requests that the user enter their mobile device model number. The model number of the mobile device enables the facility to provide the appropriate security instructions as well as implement the appropriate exchange of security keys. After receiving the mobile device model, at a block 520 the facility displays a message to the user requesting that they depress a security button on the wireless router. It the user utilizes the router 310 provided by the service provider, in some embodiments the router includes a dedicated security button that, when depressed, initiates a pairing process with the mobile device that involves the exchange of security keys. If the router does not include a dedicated security button, an alternate method of pairing is implemented as will be discussed below. An example of a security button on a router may be found in the concurrently-filed U.S. Provisional Application ______ (attorney docket number 31419.8010.US00), entitled “SYSTEM AND METHOD TO INDICATE IP-BASED WIRELESS TELECOMMUNICATIONS SERVICE AVAILABILITY,” which is herein incorporated by reference in its entirety.

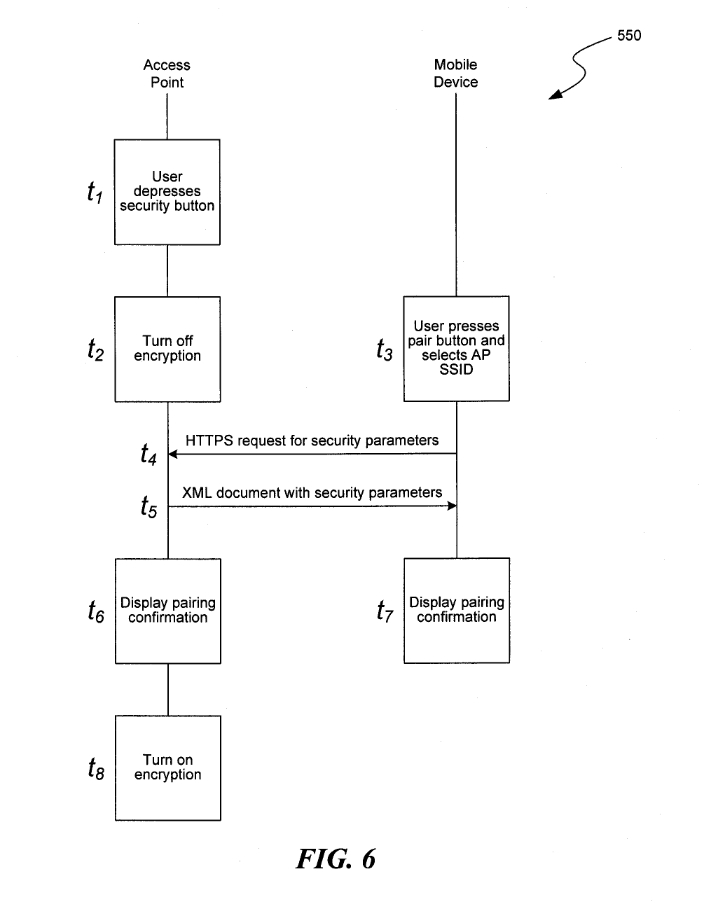

FIG. 6 is a communication diagram 550 that depicts the communication flow as part of the pairing process between the access point and the mobile device. At a time t₁, the user depresses the security button on the access point to begin the pairing process. At a time t₂, the access point turns off any encryption and prepares to receive a pairing request. At a time t₃, the user implements a pairing request by pushing a button or taking another action on the mobile device. If the mobile device is within range of only one access point, the pairing request is automatically made to that access point. If the mobile device is within range of more than one access point, the user may select which access point to pair with or an automated selection may be made for the user (e.g., an automated selection of an access point that is in a list of approved access points that are maintained by the mobile device). At a time t₄, the mobile device sends an HTTPS request for security parameters to the access point. The mobile device request is validated by the access point by a handshake process. If the request is from an authorized mobile device, at a time t₅ the access point transmits an XML document to the mobile device with appropriate security parameters to allow the mobile device to communicate with the access point. Once the mobile device has received the XML document the securing process is complete. Additional messages (not shown) may be sent between the access point and the mobile device to confirm the pairing. At a time t₆, the access point displays a confirmation that the pairing is complete. Such confirmation may take the form of a confirming LED light or other visual or auditory signal to the user. At a time t₇, the mobile device displays a confirmation that the pairing is complete. Such confirmation may take the form of a message on the mobile device screen, an aural tone, or other signal to the user. At a time t₈, the access point turns encryption back on. Future communications between the access point and the mobile device are therefore provided an appropriate level of encryption to ensure that the communication remains secure if intercepted.

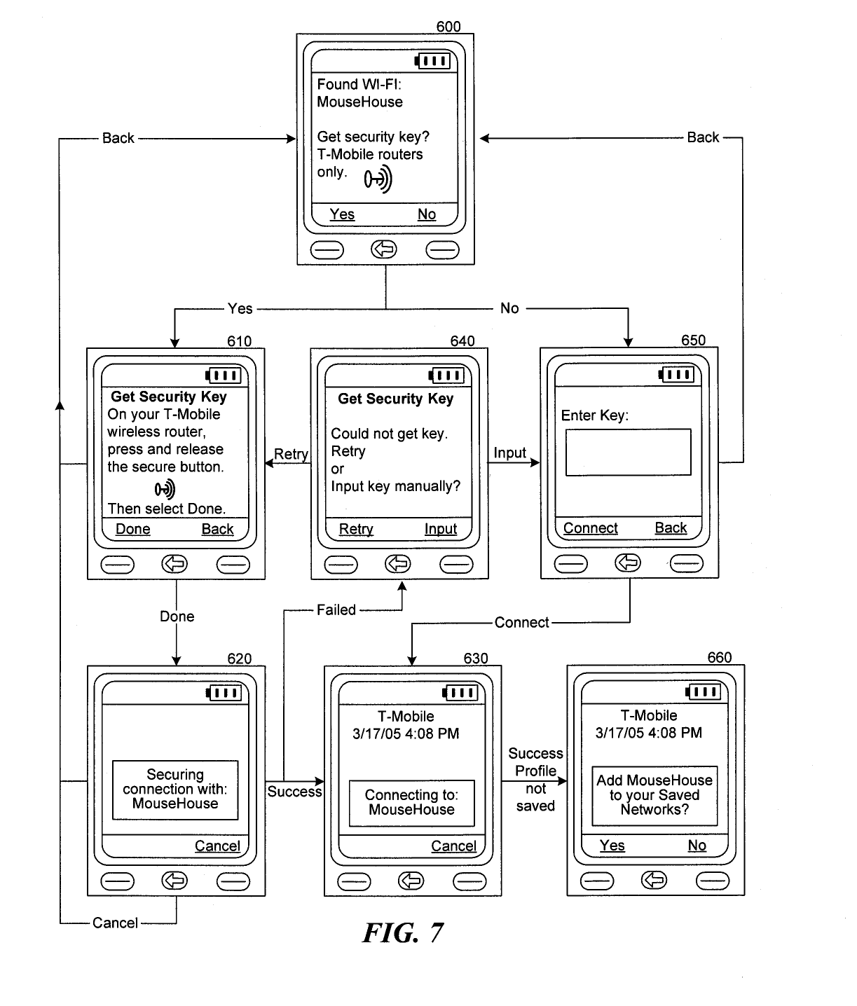

FIG. 7 contains screenshots of a representative user interface during the pairing process on a mobile device. The screenshots are arrayed in a sequence that they may be displayed to the user during the pairing process. In a first display 600, the user is notified of an access point that has been located having the SSID “MouseHouse.” The user is given the option of obtaining a security key from the router, if such functionality is available, by depressing the mobile device key corresponding to the “yes” response. If the security key is to be obtained from the wireless router, in a second display 610 the user is provided instructions to press and release the secure button on the router. In a third display 620, the user is apprised that the pairing operation between the access point and the mobile device is in progress. Such pairing operation has been previously discussed with respect to the communication diagram of FIG. 6. If the pairing operation is successful, the user is presented with a fourth display 630 that indicates that the connection with the network is being made. If the pairing operation is unsuccessful, the user is presented with a fifth display 640 that indicates that pairing has failed and provides the user with an option to retry the automatic pairing or to manually input the security key. If the user elects to retry automatic pairing, the user is presented with the second display 610 to begin the pairing process again. If the user elects to manually enter the security key, the user is presented with a sixth display 650 that provides a data entry field to allow the user to enter a WEP security key or WPA passphrase associated with the access point. The key may be entered using the mobile device keypad, using a touchscreen and stylus, or via any other data entry method. Once the mobile device has successfully paired with the access point and connection with the network established, the user is presented with a seventh display 660 that allows the user to save the access point in a list of stored networks that are maintained on the mobile device.

Returning to FIG. 5B, at a decision block 525 the facility determines whether the mobile device was successfully paired with the access point. If the mobile device was not successfully paired, at a block 530 the facility displays help information to the user and processing continues to block 520 to allow the user to re-attempt the pairing process. If the block was successfully paired, at a block 535 the facility displays a message to the user confirming that security has been enabled. The message may be displayed in a variety of forms, as was previously discussed with respect to FIGS. 6 and 7. When security has been successfully enabled, the set-up process returns to block 490.

At a decision block 540, the facility determines whether a user has selected the option of ending the set-up process. The user may end the set-up process regardless of whether they have viewed the tutorial or opted to enable security. The disclosed set-up process is simple and intuitive for all users, thereby facilitating the adoption and use of IP-based telecommunications network devices.

### III. CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples, and alternative implementations may employ differing values or ranges.

The teachings of the methods and system provided herein can be applied to other systems, not necessarily the system described above. The elements and acts of the various embodiments described above can be combined to provide further embodiments.

While certain aspects of the technology are presented below in certain claim forms, the inventors contemplate the various aspects of the technology in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the technology.

We claim:

1. A method of bundling a wireless router with other components to facilitate the deployment of the wireless router as an access point to an IP-based wireless telecommunications network for a user of a mobile communication device, the method comprising:
providing a mobile communication device that is capable of transmitting and receiving communications via an Internet Protocol wireless network;
providing a storage medium containing an installation tutorial that, when inserted into a computer that has a broadband data connection through a modem, provides instructions on how to connect a wireless router to the modem;
providing a wireless router that may be connected to the modem and that is capable of transmitting and receiving communications with the mobile device; and
providing messaging on at least one of the mobile device, the storage medium, or the wireless router, wherein the messaging indicates that the installation program on the storage medium is to be executed before additional installation steps are performed.

2. The method of bundling a wireless router of claim 1, wherein the storage medium is a compact disc.

3. The method of bundling a wireless router of claim 1, wherein the mobile communication device is a mobile phone.

4. The method of bundling a wireless router of claim 1, wherein the Internet Protocol wireless network is a wi-fi network.

5. The method of bundling a wireless router of claim 1, wherein the messaging is provided on a removable sticker.

6. The method of bundling a wireless router of claim 5, wherein the sticker is placed over cable connection points on the wireless router.

7. The method of bundling a wireless router of claim 1, wherein the messaging is on the mobile device, the storage medium, and the wireless router.

8. The method of bundling a wireless router of claim 1, wherein the messaging is further provided on product packaging that contains all of the mobile device, the storage medium, and the wireless router.

9. The method of claim 1, wherein the mobile device is a dual-mode device that is also capable of transmitting and receiving communications via a licensed-frequency cellular network.

10. A wireless router that is suitable for use as an access point to an IP-based wireless telecommunications network by a user of a mobile communication device, the wireless router comprising:
a communication component for wirelessly communicating Internet Protocol (IP) formatted data with a mobile communication device, the mobile communication device being capable of transmitting and receiving communications via an IP wireless network;
a security component coupled to the communication component for encrypting the IP-formatted data in accordance with a security parameter; and
a switch that when enabled, causes the security parameter to be transmitted to the mobile communication device so that the mobile communication device may communicate with the wireless router in a secure fashion.

11. The wireless router of claim 10, wherein the switch is a push-button.

12. The wireless router of claim 10, wherein the security component disables the encryption before transmitting the security parameter to the mobile communication device.

13. The wireless router of claim 12, wherein the security component re-enables the encryption after transmitting the security parameter to the mobile communication device.

14. The wireless router of claim 10, further comprising a display that displays when the security parameter has been successfully transmitted to the mobile communication device.

15. The wireless router of claim 14, wherein the display is an LED.

16. The wireless router of claim 10, wherein the security parameter is a WEP security key.

17. The wireless router of claim 10, wherein the security parameter is a WPA passphrase.

18. The wireless router of claim 10, wherein the mobile communication device is also capable of transmitting and receiving communications via a licensed-frequency cellular network.

19. A method of securely pairing a wireless router with a mobile communication device, the wireless router being suitable for use as an access point to an IP-based wireless telecommunications network and the communication device being capable of transmitting and receiving communications via an Internet Protocol (IP) wireless telecommunications network, the method comprising:
detecting the selection of a security switch at the wireless router by a user;
disabling encryption applied by the wireless router to the transmission of IP-formatted data;
transmitting a security parameter to the mobile communication device, wherein the mobile communication device may communicate with the wireless router in a secure fashion after receipt of the security parameter; and
re-enabling encryption applied by the wireless router to the transmission of IP-formatted data.

20. The method of claim 19, further comprising the step of receiving confirmation from the mobile communication device that is received the security parameter.

21. The method of claim 20, further comprising displaying a visual indication to the user that the mobile communication device has received the security parameter.

22. The method of claim 19, wherein the security parameter is a WEP security key.

23. The method of claim 19, wherein the security parameter is a WPA passphrase.

24. The method of claim 19, wherein the mobile device is a dual-mode device that is capable of transmitting and receiving communications via a licensed-frequency cellular network.
